(19) United States
(12) Patent Application Publication
(10) Pub. No.: US 2010/0002765 A1
(43) Pub. Date: Jan. 7, 2010

(54) Image encoding apparatus and method

(75) Inventors: Masatoshi Kondo, Tokyo (JP); Muneaki Yamaguchi, Tokyo (JP)

Correspondence Address: BACON & THOMAS, PLLC, 625 SLATERS LANE, FOURTH FLOOR, ALEXANDRIA, VA, 22314-1176, US

(73) Assignee: Hitachi Kokusai Electric Inc., Tokyo (JP)

(21) Appl. No.: 12/457,863

(22) Filed: Jun. 24, 2009

(30) Foreign Application Priority Data
Jul. 1, 2008 (JP) 2008-172410

(51) Int. Cl. H04N 7/32

(52) U.S. Cl. 375/240.12; 375/E07.243

(57) ABSTRACT

An image encoding apparatus includes a calculation unit for calculating complexity from pixel values of an input image, the complexity representing a code amount generated by prediction encoding each block included in a prediction target region of the input image, and an allocation unit for allocating a code amount to each block based on the calculated complexity of each block and an allowable code amount previously set for the prediction target region. The apparatus further includes a determination unit for determining an encoding parameter corresponding to each block based on the complexity of each block and the code amount allocated to each block, and an encoding unit for encoding each block by using the determined encoding parameter of each block. Finally, the apparatus includes a resetting unit for resetting the allowable code amount for a next prediction target region based on an occupancy amount of a buffer.

### FIELD OF THE INVENTION

The present invention relates to an image encoding apparatus and method for encoding a moving picture.

### BACKGROUND OF THE INVENTION

In an image encoding scheme such as MPEG-2 (Moving Picture Experts Group, ISO/IEC 13818-1), H.264 (ISO/IEC 14496-10) or the like, the amount of encoded data (referred to as “code amount”, hereinafter) is varied according to complexity of an input image or an encoding method. Accordingly, an image transmission system using an image encoding technique requires a buffer for absorbing variation in the code amount to realize sequential reproduction of an encoded bit stream.

In order to realize sequential reproduction with a limited buffer size, it is necessary to control variation in the code amount to prevent overflow and underflow of the buffer. The control of the code amount is realized by varying a quantization parameter. If buffer occupancy becomes larger, the quantization parameter is set to be increased, whereas if buffer occupancy becomes smaller, the quantization parameter is controlled to be decreased, thereby controlling the generated code amount. For example, MPEG-2 TM5 is well known as a code amount control technique (see, e.g., Non-patent Document 1).

In a conventional code amount control method, the code amount is controlled to be constant in each GOP (Group Of Pictures). Further, the code amount in each picture (i.e., frame or field) of the GOP is allocated according to the encoding method of each picture (i.e., whether the picture is an I, P, or B-picture). The code amount for each macroblock in the picture may be determined by evenly dividing the code amount allocated to the picture.

The code amount needed for encoding each macroblock may be changed according to image complexity therein. In order to constantly maintain the code amount which is bound to fluctuate in each macroblock, it is necessary to vary the quantization parameter. However, the variation of the quantization parameter may lead to nonuniformity in the image quality within a picture.

In Patent Document 1, in order to reduce the variation of the quantization parameters and achieve the uniformity of the image quality, the variation in the code amount of a current picture is predicted from quantization parameters and generated code amounts of previously encoded pictures by using temporal correlation of the images, and the allocation of the code amount is carried out according to the variation in the code amount.

[Non-patent Document 1] MPEG-2 TM5 Chapter. 10 RATE CONTROL AND QUANTIZATION CONTROL (http://www.mpeg.org/MPEG/MSSG/tm5/Ch10/Ch10.html)

[Patent Document 1] Japanese Patent Laid-open Application No. H6-197329

However, in the method of Patent Document 1, when the temporal correlation of the images is considerably low, for example, due to scene change or rapid panning of the camera, prediction of the variation in the code amount is poorly carried out and, thus, it is necessary to largely vary the quantization parameter. Consequently, in the conventional technique, it is difficult to achieve the uniformity of the image quality when the temporal correlation of the images is considerably low.

### SUMMARY OF THE INVENTION

In view of the above, the present invention provides an image encoding apparatus and method for encoding a moving picture, which is capable of maintaining the uniformity of the image quality even though the temporal correlation of the images is low.

In accordance with a first aspect of the present invention, there is provided an image encoding apparatus which prediction encodes a block having a specified pixel region of an input image and outputs encoded image data via a buffer, the apparatus comprising: a calculation unit for calculating complexity from pixel values of an input image, the complexity representing a code amount generated by prediction encoding each block included in a prediction target region of the input image; and an allocation unit for allocating a code amount to each block based on the calculated complexity of each block and an allowable code amount previously set for the prediction target region. The apparatus may further include a determination unit for determining an encoding parameter corresponding to each block based on the predicted complexity of each block and the code amount allocated to each block; an encoding unit for encoding each block by using the determined encoding parameter of each block; and a resetting unit for resetting the allowable code amount for a next prediction target region based on an occupancy amount of the buffer in which the encoded data are accumulated.

In accordance with a second aspect of the present invention, there is provided an image encoding method used in an image encoding apparatus which prediction encodes a block having a specified pixel region of an input image and outputs encoded image data via a buffer, the method comprising: calculating complexity from pixel values of an input image, the complexity representing a code amount generated by prediction encoding each block included in a prediction target region of the input image; allocating a code amount to each block based on the calculated complexity of each block and an allowable code amount previously set for the prediction target region; determining an encoding parameter corresponding to each block based on the predicted complexity of each block and the code amount allocated to each block; encoding each block by using the determined encoding parameter of each block; and resetting the allowable code amount for a next prediction target region based on an occupancy amount of the buffer in which the encoded data are accumulated.

In accordance with the aspects of the present invention, it is possible to provide an image encoding apparatus and an image encoding method capable of maintaining the uniformity of the image quality.

### BRIEF DESCRIPTION OF THE DRAWINGS

The objects and features of the present invention will become apparent from the following description of embodiments given in conjunction with the accompanying drawings, in which:

FIG. 1 is a functional block diagram of an image encoding apparatus in accordance with an embodiment of the present invention;

FIG. 2 is a block diagram of a configuration of an image complexity calculation unit of FIG. 1;

FIG. 3 shows a block diagram of a configuration of a code amount allocation unit of FIG. 1;

FIG. 4 is a block diagram of a configuration of a quantization parameter calculation unit of FIG. 1; and

FIG. 5 illustrates an example of an encoding process using the image encoding apparatus shown in FIG. 1.

### DETAILED DESCRIPTION OF THE EMBODIMENTS

Hereinafter, embodiments of the present invention will be described in detail with reference to the accompanying drawings which form a part hereof.

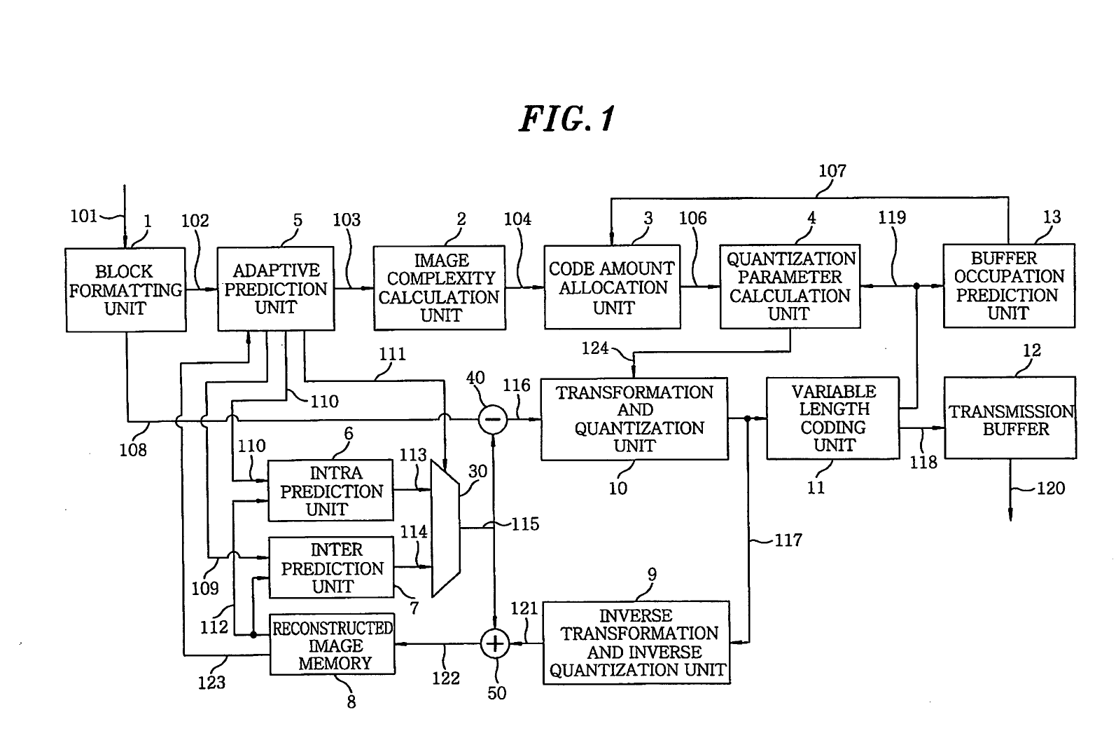

FIG. 1 is a functional block diagram of an image encoding apparatus in accordance with an embodiment of the present invention.

Referring to FIG. 1, image signals are inputted to a block formatting unit 1 via a line 101. A picture is decomposed into scanning lines to obtain image signals, which are transmitted by serial data transmission defined by, e.g., SMPTE 292M. The block formatting unit 1 is a delay circuit. The block formatting unit 1 accumulates data the amount of which corresponds to one row of macroblocks (MBs) and, then, outputs pixel data of each macroblock of 16×16 pixels to an adaptive prediction unit 5 via a line 102. Further, the block formatting unit 1 outputs the pixel data of the macroblock to a line 108 after delay until allocation of an allowable code amount to a complexity prediction region and calculation of a quantization parameter, which will be described later, are completed.

The adaptive prediction unit 5 performs an adaptive intra-prediction process using intra-picture correlation and an adaptive inter-prediction process using inter-picture correlation by using the pixel data of the macroblock inputted through the line 102 and reconstructed image data inputted through a line 123. Further, the adaptive prediction unit 5 outputs a most appropriate prediction mode signal, which represents a position of the most similar candidate macroblock in the reconstructed image data, to an intra-prediction unit 6 via a line 110 or an inter-prediction unit 7 via a line 109. Further, the adaptive prediction unit 5 outputs to a selector 30 via a line 111 an intra/inter determination signal regarding whether the most similar candidate macroblock of the input macroblock was obtained by the intra-prediction or the inter-prediction. If the most similar macroblock was obtained by the intra(or inter)-prediction, the prediction mode signal is provided to the intra-prediction unit 6 (or inter-prediction unit 7).

In determining the most appropriate prediction mode signal for encoding of the input macroblock data, the adaptive prediction unit 5 calculates differences between candidate macroblocks and the input macroblock. Then, the adaptive prediction unit 5 determines the prediction mode, e.g., position information of the most similar macroblock, which yields the smallest difference, as the most appropriate prediction mode. The difference data corresponding to the most appropriate prediction mode, i.e., the difference between the input macroblock and the most similar candidate macroblock, is outputted to an image complexity calculation unit 2 via a line 103.

The image complexity calculation unit 2 calculates complexity of a macroblock based on the input difference data and outputs the complexity to a code amount allocation unit 3 through a line 104. In this embodiment, the complexity is defined as SAD (Sum of Absolute Difference) which is the sum of absolute values of the input difference data (i.e., the pixel difference data). The complexity is a parameter for predicting a generated code amount of the input data, and is not limited to SAD. For example, a block such as a transformation and quantization unit 10 may be provided in the image complexity calculation unit 2. In such a case, the same process as in the transformation and quantization unit 10 is performed on the difference data to obtain output data, and the output data may be considered as the complexity. Further, a block such as a variable length coding unit 11 may be further provided in the image complexity calculation unit 2 to output a generated code amount, and the generated code amount may be used as a complexity index for determining a quantization parameter.

The code amount allocation unit 3 calculates an allowable code amount to be allocated to a complexity prediction region based on the estimated complexity of the complexity prediction region and a buffer occupancy amount. Details of the complexity prediction region will be described later. Further, the code amount allocation unit 3 allocates the allowable code amount to macroblocks according to the complexity distribution of the macroblocks in the complexity prediction region. The code amount allocation unit 3 outputs the code amount allocated to each macroblock and the complexity thereof via a line 106.

A quantization parameter calculation unit 4 calculates a quantization parameter based on the code amount allocated to each macroblock and the complexity thereof inputted via the line 106 and the actually generated code amount of each macroblock inputted via a line 119, and then outputs the calculated quantization parameter via a line 124.

The intra-prediction unit 6 reads reconstructed image data required for prediction from a reconstructed image memory 8 via a line 112 in response to the prediction mode signal inputted via a line 110. Then, the intra-prediction unit 6 outputs on a line 113 the read reconstructed image data as intra-prediction image data based on the designated prediction mode. As for the intra-prediction, an intra-picture correlation based prediction method used in H. 264/AVC (ISO/IEC 14496-10) is well known.

The inter-prediction unit 7 reads reconstructed image data required for prediction from the reconstructed image memory 8 via the line 112 in response to the prediction mode signal inputted via the line 109. Then, the inter-prediction unit 7 outputs on a line 114 the read reconstructed image data as inter-prediction image data based on the designated prediction mode.

The selector 30 selects the prediction image data outputted via the line 113 or 114 based on the intra/inter determination signal inputted from the line 111 and outputs the selected prediction image data via a line 115.

A subtracter 40 subtracts the selected prediction image data from the pixel data of the current macroblock outputted on the line 108 to produce the difference data, and outputs the difference data via a line 116.

The transformation and quantization unit (T/Q unit) 10 performs a transformation process and a quantization process based on a quantization parameter on the difference data inputted via the line 116. Then, the T/Q unit 10 outputs the quantized data via a line 117. An inverse quantization and inverse transformation unit (IQ/IT unit) 9 performs an inverse quantization process and an inverse transformation process on the quantized data inputted from the line 117 and outputs reconstructed difference data to a line 121.

The variable length coding (VLC) unit 11 transforms the quantized data inputted from the T/Q unit 10 into variable length coded data, and outputs the variable length coded data to a transmission buffer 12 via a line 118. Further, the VLC unit 11 outputs the code amount of the variable length coded data to the quantization parameter calculation unit 4 and a buffer occupation prediction unit 13 via a line 119.

The transmission buffer 12 outputs the variable length coded data accumulated therein to a line 120 for the transmission thereof at a predetermined transmission rate after a specified delay time period.

The buffer occupation prediction unit 13 calculates a buffer occupancy amount based on the generated code amount inputted from the line 119 and the data transmission rate of the transmission buffer 12.

Further, an adder 50 adds the reconstructed difference data inputted from the line 121 to the prediction image data inputted from the line 115 to produce the reconstructed image data. The reconstructed image data are inputted to the reconstructed image memory 8 via a line 122.

The reconstructed image memory 8 is a random access memory. The reconstructed image memory 8 outputs the reconstructed image data stored at addresses designated by the adaptive prediction unit 5, the intra-prediction unit 6 and the inter-prediction unit 7 via the lines 123 and 112, respectively.

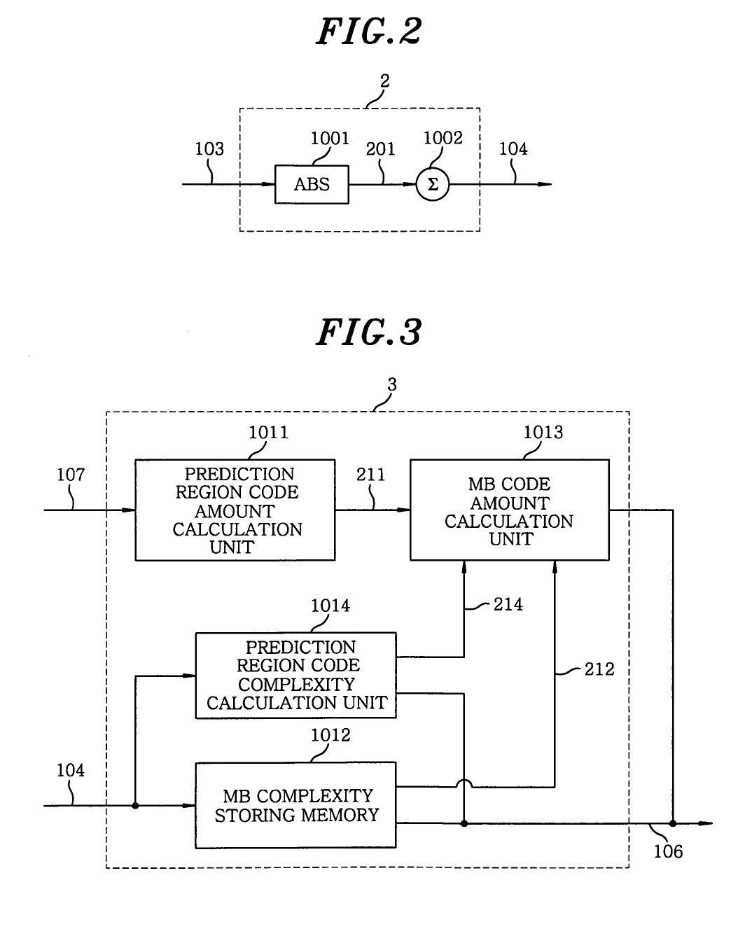

The detailed configuration of the image complexity calculation unit 2 of FIG. 1 is illustrated in FIG. 2.

In the image complexity calculation unit 2 of this embodiment, an ABS 1001 calculates absolute values of the difference image data inputted from the line 103 and outputs the absolute values of the difference data via a line 201. Then, a cumulative addition circuit 1002 calculates the sum of the absolute values of the difference data and outputs the sum of the absolute values via the line 104.

The detailed configuration of the code amount allocation unit 3 of FIG. 1 is illustrated in FIG. 3.

A prediction region code amount calculation unit 1011 calculates an allowable code amount to be allocated to the entire complexity prediction region by using the buffer occupancy amount inputted from the buffer occupation prediction unit 13 via the line 107 and the predetermined transmission rate of the transmission buffer 12. The calculated allowable code amount is outputted via a line 211. The prediction region code amount calculation unit 1011 calculates the allowable code amount, e.g., whenever the variable length coding unit 11 performs an encoding process corresponding to one row of macroblocks. The complexity of each macroblock inputted via the line 104 is inputted to a macroblock (MB) complexity storing memory 1012 and a prediction region complexity calculation unit 1014. The MB complexity storing memory 1012 may output the complexity of each macroblock on the line 106.

The prediction region complexity calculation unit 1014 calculates the total sum of the complexities of the macroblocks in the entire complexity prediction region having multiple rows of macroblocks by using the complexity of each macroblock inputted via the line 104, and outputs the total sum via the line 214. To be specific, the prediction region complexity calculation unit 1014 calculates the total complexity of each row of macroblocks in the complexity prediction region by summing complexities of macroblocks in each row of macroblocks. The prediction region complexity calculation unit 1014 includes a memory or a plurality of resisters to store the total complexity per one row of macroblocks. The memory or the resisters have a capacity of storing the total complexity in each row of macroblocks in the complexity prediction region and the total complexity of one additional row of macroblocks. For example, if there exist 10 rows of macroblocks in the complexity prediction region, the prediction region complexity calculation unit 1014 can separately store the 11 total complexities of the 10 rows of macroblocks in the prediction region and one additional row of macroblocks. The prediction region complexity calculation unit 1014 may further output the total complexity of each row of macroblocks to the line 106.

The prediction region complexity calculation unit 1014 adds the total complexity of one row of macroblocks to be newly included to the complexity prediction region and subtracts the total complexity of one row of macroblocks to be excluded therefrom to and from the total sum of complexities of the macroblocks in the entire complexity prediction region to update the total sum, e.g., whenever the variable length coding unit 11 completes the encoding process corresponding to one row of macroblocks. A row of macroblocks will be referred to as “macroblock line” hereinafter.

A macroblock (MB) code amount calculation unit 1013 calculates the code amount to be allocated to each macroblock based on the allowable code amount for the complexity prediction region inputted via the line 211, the complexity of each macroblock inputted via the line 212, and the total complexity of the entire complexity prediction region inputted via the line 214, and outputs the code amount for each macroblock to the line 106.

For example, the code amount B_mb[i] allocated to a macroblock[i] in this embodiment may be obtained by the following Eq. 1:

B_{—}mb[i]=B×(C[i]/TC) Eq. 1,

where B is the allowable code amount for the entire complexity prediction region; C[i] is the complexity of the macroblock[i]; and TC is the total complexity of the entire complexity prediction region, i representing an index of the macroblock[i] in the complexity prediction region.

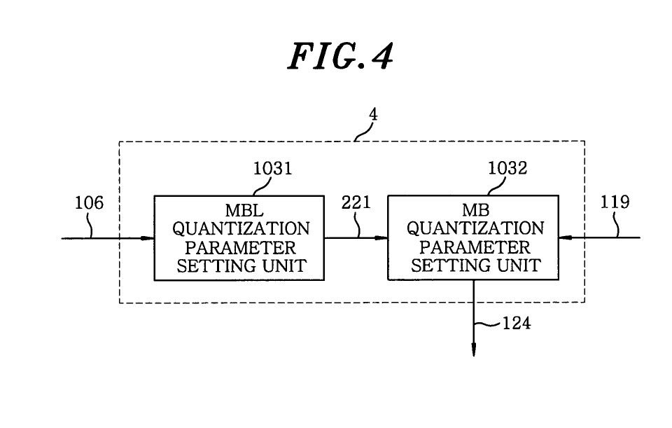

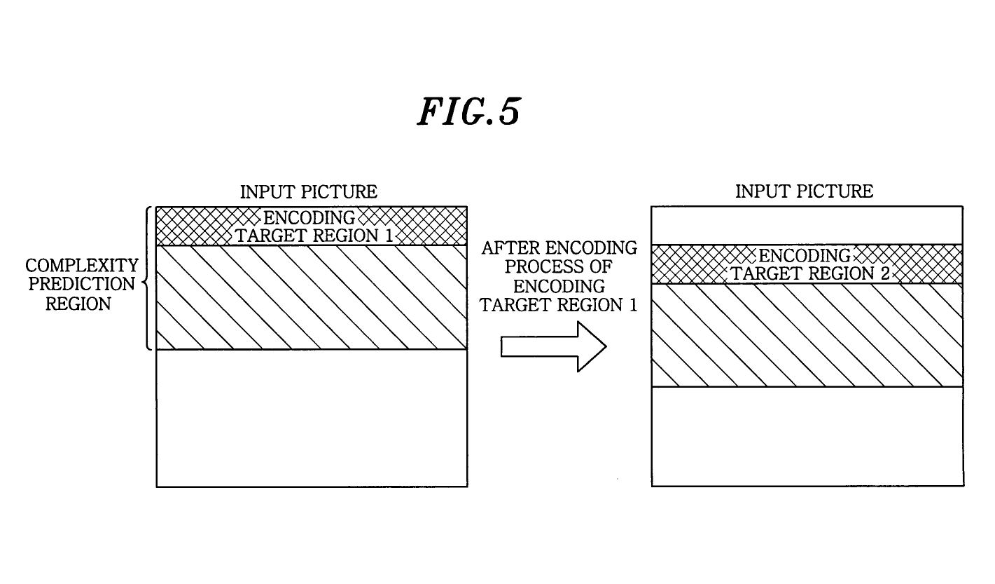

Next, the detailed configuration of the quantization parameter calculation unit 4 of FIG. 1 is illustrated in FIG. 4.

A macroblock line (MBL) quantization parameter setting unit 1031 calculates a most appropriate quantization parameter in encoding a target MBL with the allowable code amount allocated to the target MBL by using the complexity of each macroblock or, preferably, the complexity of the MBL, and the code amount allocated to each macroblock in the target MBL inputted via the line 106.

The quantization parameter for the target MBL can be obtained by Eqs. 2 and 3 as follows. In Eqs. 2 and 3, C_MBL is the total complexity of the target MBL; B_MBL is the allowable code amount of the target MBL; Q_MBL is the quantization parameter for the target MBL; and Bpred[Q] is a predicted code amount when the encoding is performed by using a certain quantization parameter. In this embodiment, the MBL quantization parameter setting unit 1031 calculates Bpred[Q] from the linear equation Eq. 2 by using a certain appropriate quantization parameter (Q_tmp) and the total complexity of the MBL (C_MBL).

Bpred[Q_{—}tmp]=α×C_{—}MBL+β Eq. 2.

Then, the Q_MBL is obtained as follows.

Q_{—}MBL=(Bpred[Q_{—}tmp]/B_{—}MBL)×Q_{—}tmp Eq. 3.

The MBL quantization parameter setting unit 1031 outputs the code amount allocated to each macroblock and Q_MBL on a line 221.

In this embodiment, from the statistical results of the generated code amount as a function of complexity and quantization parameter, Bpred can be calculated by using Q_tmp=26, α=0.0226 and β=134, enabling to predict the generated code amount with high accuracy.

Further, since an error can be generated between the code amount predicted based on the complexity and the actual code amount generated when the encoding process is actually performed, the buffer may be overflown or underflown if the errors are accumulated. Accordingly, in the quantization parameter calculation unit 4, a macroblock (MB) quantization parameter setting unit 1032 adjusts the quantization parameter to be used in encoding a next macroblock based on the difference between the actually-generated code amount of each macroblock inputted via the line 119 and the code amount allocated to each macroblock inputted via the line 221 such that the buffer is neither overflown nor underflown due to the accumulated errors, and outputs the adjusted quantization parameter for the next macroblock via a line 124.

The quantization parameter Q_MB[i] to be used in encoding the next macroblock[i] can be obtained by the following Eq. 4:

Q_{MB}[i]=(B_{MB}[i]/(B_{MB}[i]−EB))×Q_{MBL} Eq. 4,

where EB is the cumulative value of the differences between the generated code amounts and the allocated code amounts and B_MB[i] is the code amount allocated to the next macroblock[i] to be encoded.

As described above, in the image encoding apparatus of the present embodiment, as shown in FIG. 5, even when the complexity of only several MBLs can be predicted, the allowable code amount is renewed and the quantization parameter is recalculated whenever an encoding process of one MBL is completed, thereby enabling to suppress the variation in the image quality.

In the conventional method, when the temporal correlation of the images is low, for example, due to scene change or rapid panning of the camera, it is difficult to predict the variation in the code amount and, thus, it is necessary to largely vary the quantization parameter. Consequently, in the conventional technique, it is difficult to achieve the uniformity of the image quality when the temporal correlation of the images is considerably low.

On the contrary, in this embodiment, the complexity of each macroblock of the input image is calculated and the code amount is allocated to each macroblock according to the complexity. Consequently, even when there is low correlation with the previous picture, it is possible to suppress the variation of the quantization parameter and the deterioration of the image quality and stably control the buffer. Further, since the complexity prediction region is slid by one macroblock line whenever the encoding process of each macroblock line is performed, and the complexity, the allocated code amount and the quantization parameter of the macroblock are recalculated, it is possible to suppress the image variation between the complexity prediction regions.

Therefore, in accordance with the above embodiment, even when there is low temporal correlation of the images, it is possible to achieve the image encoding apparatus capable of maintaining the uniformity of the image quality. In particular, the image encoding apparatus of this embodiment can transmit the images having high quality with a delay time smaller than one picture period, and thus can be applied to a field requiring small delay image transmission such as image material transmission, television conference, remote medical service.

While the invention has been shown and described with respect to the embodiments, it will be understood by those skilled in the art that various changes and modifications may be made without departing from the scope of the invention as defined in the following claims.

What is claimed is:

1. An image encoding apparatus which prediction encodes a block having a specified pixel region of an input image and outputs encoded image data via a buffer, the apparatus comprising:
a calculation unit for calculating complexity from pixel values of the input image, the complexity representing a code amount generated by prediction encoding each block included in a prediction target region of the input image;
an allocation unit for allocating a code amount to each block based on the calculated complexity of each block and an allowable code amount previously set for the prediction target region;
a determination unit for determining an encoding parameter corresponding to each block based on the complexity of each block and the code amount allocated to each block;
an encoding unit for encoding each block by using the determined encoding parameter of each block; and
a resetting unit for resetting the allowable code amount for a next prediction target region based on an occupancy amount of the buffer in which the encoded data are accumulated.

2. An image encoding method used in an image encoding apparatus which prediction encodes a block having a specified pixel region of an input image and outputs encoded image data via a buffer, the method comprising:
calculating complexity from pixel values of the input image, the complexity representing a code amount generated by prediction encoding each block included in a prediction target region of the input image;
allocating a code amount to each block based on the calculated complexity of each block and an allowable code amount previously set for the prediction target region;
determining an encoding parameter corresponding to each block based on the complexity of each block and the code amount allocated to each block;
encoding each block by using the determined encoding parameter of each block; and
resetting the allowable code amount for a next prediction target region based on an occupancy amount of the buffer in which the encoded data are accumulated.
